(19) United States
(12) Patent Application Publication
(10) Pub. No.: US 2017/0130601 A1
(43) Pub. Date: May 11, 2017

(54) GAS TURBINE ENGINE STAGE PROVIDED WITH A LABYRINTH SEAL

(71) Applicant: GE AVIO S.r.l., Rivalta Di Torino (IT)

(72) Inventor: Daniele COUTANDIN, Avigliana (IT)

(21) Appl. No.: 15/348,657

(22) Filed: Nov. 10, 2016

(30) Foreign Application Priority Data
Nov. 11, 2015 (IT) 102015000071537

(51) Int. Cl. F01D 11/12; F01D 9/02; F01D 5/02; F01D 11/02

(52) U.S. Cl. CPC F01D 11/122; F01D 11/02; F01D 9/02; F01D 5/02; F05D 2220/32; F05D 2240/307

(57) ABSTRACT

In a gas turbine engine stage, a labyrinth seal has a layer of abradable material arranged on a static part and radially delimited by a cylindrical surface, which is continuous and has a constant diameter in an initial assembly configuration; the seal has at least three tabs, which are arranged on the rotating part, radially facing the abradable material, and are constituted by two side tabs and an intermediate tab having a smaller radial height; this height still allows the abradable material to be engraved, due to the effect of thermal expansion and of the relative rotation during operation; the tabs are positioned axially in such a way that, in the running operational configuration, the layer of abradable material has two seats, which have been fretted by the tips of the two side tabs during operation, and are axially separated by a step, while the intermediate tab is arranged at said step.

The present invention relates to a gas turbine engine stage provided with a labyrinth seal, in particular for aeronautical applications.

### BACKGROUND OF THE INVENTION

Labyrinth seals are widely used between the stator and the rotor in aeronautical turbines, to limit the passage of gas streams from a higher pressure cavity to a lower pressure one. As is known, the labyrinth seal works by trying to create a narrow and tortuous passage for the drawn gas flow, so as to increase the head losses due to friction and the concentrated head losses (due to inlets, outlets, deviations etc.).

To maximize the sealing properties, labyrinth seals of the known type have one part on the stator, defined by a layer of abradable material (typically of the honeycomb type), and one part on the rotor, composed of a series of radial tabs that project towards the layer of abradable material with heights equal to each other and which are spaced apart along the axis of the turbine.

During operation of the engine, typically, the rotating components expand to a greater extent compared to the stator components. The seal is configured such that, during operation, the tip of each radial tab frets a corresponding seat within the layer of abradable material, because of thermal expansion and of the relative rotation.

Once the seats have been fretted, a steady-state operation is obtained, in which the tips of the radial tabs are located in said seats. This configuration helps to increase the head losses and thereby improve the sealing properties, as it increases the tortuosity of the gas path and narrows as much as possible the passage cross section for these gases.

This configuration also allows the components of the stage to be mounted axially without having to take special precautions to ensure a seal between the stator and the rotor, as the calibrated coupling of the labyrinth seal is obtained in a substantially automatic manner, directly during operation of the turbine engine.

This configuration also has the advantage that each radial tab digs its own seat in the most appropriate way on the basis of relative movements in each engine. In other words, the abradable-material labyrinth seal adapts to the operating conditions of the engine on which it is arranged, reaching the optimal clearance condition between the stator and the rotor, without the need for adjustments to achieve such optimal clearance.

However, in low-pressure turbine stages, the stator and rotor components move relative to each other not only in the radial direction, but also in the axial direction. These relative movements in the axial direction between the stator and the rotor are typically very large when compared with the penetration of the tabs into the layer of abradable material in the radial direction. This means that a relatively high distance must be maintained between two consecutive radial tabs so that the seats in the abradable material are fretted correctly and that the presence of a labyrinth path for the gas flow is ensured. In fact, if these two tabs were too close together, the respective seats would substantially overlap, thereby defining a single continuous seat with no labyrinth path for the gas flow.

In parallel, to increase the sealing performance, a greater number of radial tabs should be included, in order to increase the pressure losses and reduce the overall flow rate of gas drawn through the seal, the pressure drop being equal. However, the need to space the tabs sufficiently from one another and to increase the number thereof would, all in all, lead to a seal having relatively high axial dimensions, with negative impact on the overall dimensions, the weight and the turbine engine surfaces to be cooled.

### SUMMARY OF THE INVENTION

The object of the present invention is to provide a gas turbine engine stage provided with a labyrinth seal which allows the above problems to be solved in a simple and inexpensive way.

According to the present invention, a gas turbine engine stage is provided as defined in claim 1.

### BRIEF DESCRIPTION OF THE DRAWINGS

The invention will now be described with reference to the accompanying drawings, which illustrate a non-limiting embodiment thereof, in which:

FIG. 1 is a schematic radial section of a preferred embodiment of the gas turbine engine stage provided with a labyrinth seal according to the present invention;

FIG. 2 shows, in enlarged scale, the labyrinth seal of FIG. 1 at the end of the stage assembly before putting into operation the turbine engine; and

FIG. 3 is similar to FIG. 2 and shows the labyrinth seal in a running operational condition during operation of the turbine engine.

### DETAILED DESCRIPTION OF THE INVENTION

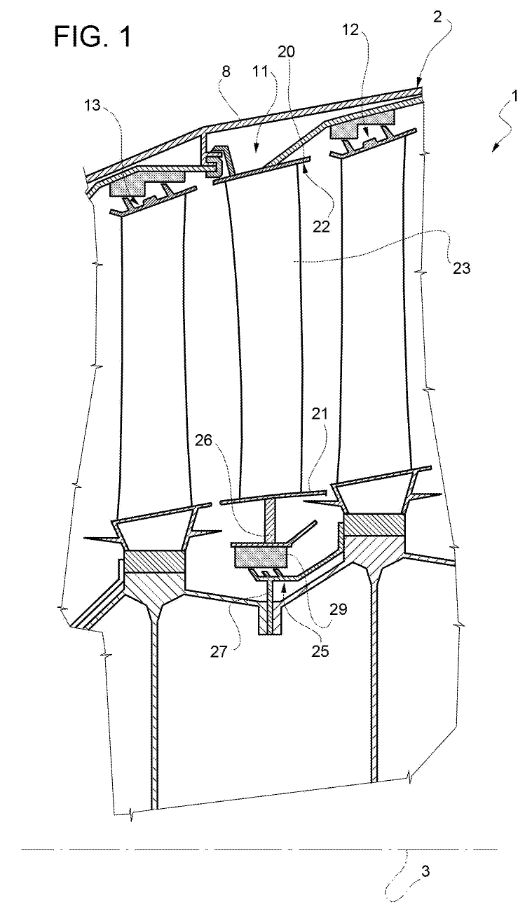

In FIG. 1, the reference number 1 designates a stage (illustrated partially and schematically) defining part of a low-pressure axial turbine 2, which in turn defines part of a gas turbine engine, particularly for aeronautical applications.

The turbine 2 has an axial symmetry with respect to an axis 3 coinciding with the engine axis and comprises a shell or casing 8 housing a succession of coaxial stages, one of which is defined by stage 1.

The stage 1 comprises a stator 11 and a bladed rotor 12, which is arranged downstream of the stator 11 (considering the axial direction of the forward movement of the gas flow in the turbine 2), is coaxial with the stator 11, is fixed with respect to the bladed rotors 13 of the other stages and to a drive shaft (not illustrated) and is able to rotate around the axis 3. Instead, the stator 11 is substantially fixed with respect to the casing 8 and comprises two annular walls 20, 21 radially delimiting between them an annular conduit 22 with a diameter increasing in the forward movement direction of the gas flow passing through the turbine 2. The stator 11 comprises an array of blades 23 fixed to the walls 20, 21, arranged in the conduit 22 in angularly spaced positions around the axis 3 and delimiting between them, in a circumferential direction, a plurality of gas flow nozzles.

Preferably, the stator 11 is composed of a plurality of sectors, next to one another in a circumferential direction, and each consisting of a part of the wall 20, a part of the wall 21 and at least one blade 23. Advantageously, the bladed rotor 12 is assembled separately from the other components: after this assembly, the bladed rotor 12 is inserted into the casing 8 along the axis 3 towards the stator 11 and is then fixed to the rotor 13 of the preceding stage and/or to the drive shaft.

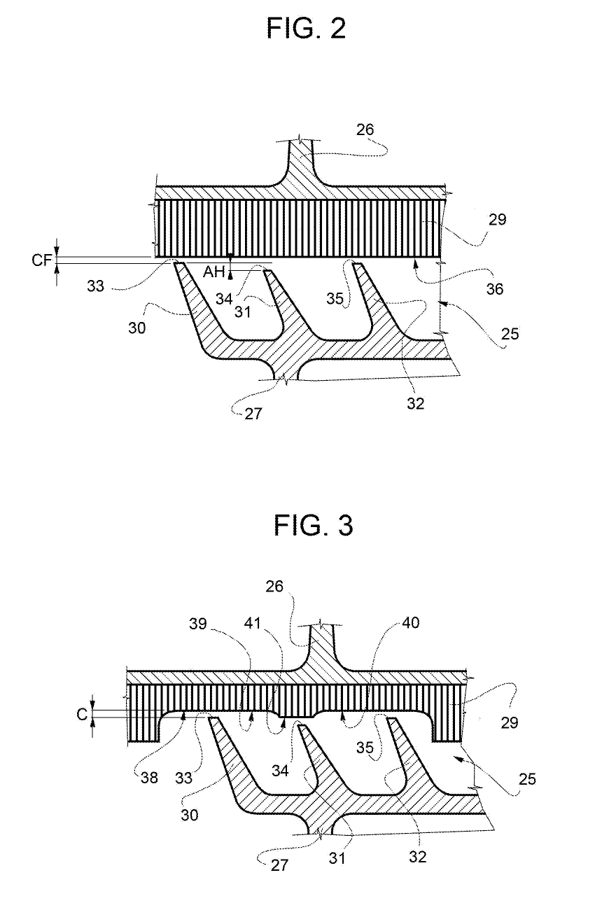

At least one labyrinth seal 25 is provided in the stage 1 to limit gas leakage to the outside of the conduit 22. With reference to FIG. 2, the seal 25 extends as a ring in a continuous manner along the whole circumference and is radially arranged between a static part 26 (defining part of the stator 11) and a rotating part 27 (defining part of the bladed rotor 12), coaxial and concentric with each other and with respect to the axis 3. The seal 25 comprises a layer of abradable material 29, for example a layer of honeycomb-like material, which is arranged in a fixed position on the static part 26 and is continuous in the axial direction (i.e. the layer 29 is not constituted by separate blocks spaced by portions of the static part 26). The seal 25 also comprises at least three tabs 30, 31 and 32 arranged in positions that are fixed with respect to the rotating part 27 and are axially spaced apart from each other. The tabs 30, 31 and 32 are defined by respective circular lips, which project radially from part 27 and end with respective circular tips or edges 33, 34 and 35, which directly face the layer of abradable material 29 in the radial direction.

FIG. 2 shows a cross section of the initial assembly configuration of the seal 25, at the end of the assembly and before the operation of the turbine 2. In this initial assembly configuration, the layer of abradable material 29 is radially defined by a continuous cylindrical surface 36 having a constant diameter, i.e. devoid of steps, facing the tips 33, 34 and 35, with radial clearance. This configuration and shape of the surface 36 allows the rotating part 27 to be mounted axially without causing interference between the tabs 30, 31 and 32 and the layer of abradable material 29.

On the other hand, FIG. 3 shows the “hot”, operational configuration of the seal 25, namely the operational configuration during the steady-state operation established at the design stage for the turbine 2. To reach this operational configuration, the tips 33, 34 and 35 have nicked part of the layer of abradable material 29, due to the effect of thermal expansion and of the relative rotation. Therefore, the layer of abradable material 29 is no longer radially defined by the surface 36, but by a shaped surface 38 that, together with the tips 33, 34 and 35, defines a labyrinth path for the gas flow that tries to leak out of the conduit 22.

According to one aspect of the present invention, the tab 31 is arranged between the tabs 30 and 32 and has a smaller radial height than the tabs 30 and 32.

The difference in radial height ΔH (FIG. 2) between the tip 34 and the tips 33, 35 must be at least equal to a minimum threshold defined by the radial clearance C (FIG. 3) that occurs in the hot, operational configuration between the tips 35 and the surface 38, so as to generate a minimal labyrinth path effect for the gas flow that tends to leak. This radial clearance C is estimated at the design stage through suitable computer simulation programs.

At the same time, the difference in radial height ΔH between the tip 34 and the tips 33, 35 must be less than or equal to a maximum threshold defined by the difference between:
an estimate (performed at the design stage by means of suitable computer simulation programs) of the maximum relative displacement in the radial direction between the parts 26 and 27 due to thermal expansion (thus corresponding to the magnitude of the approach in the radial direction between the parts 26 and 27), and
the radial clearance CF (FIG. 2) which is detected in the initial assembly configuration between the tips 33, 35 and the surface 36.

This condition is necessary to ensure that the tip 34 of the tab 31 actually reaches the surface 36 so as to engrave it, and therefore to abrade the material of the layer 29 when the turbine 2 is put into operation.

Furthermore, the relative axial positions of the tabs 30, 31 and 32 are determined at the design stage and configured so that, in the running, i.e. “hot”, operational configuration:
the surface 38 defines two seats 39 and 40, which have been fretted by the tips 33 and 35, respectively, during operation, house said tips 33 and 35, and are axially separated from each other by a step or protrusion, defined by a cylindrical region 41 of the surface 38, and
the tip 34 is located at the cylindrical region 41, which was formed by means of abrasion of the material by the tip 34 itself during operation.

The axial distance between the tabs 30 and 32 is set so as the axial separation between the seats 39 and 40 is achieved as a function of the relative axial displacements between the parts 26 and 27, between the initial assembly condition and the running operational condition, on the basis of estimates made at the design stage on thermal expansion, for example performed by means of simulations with suitable computer programs. Similarly, the axial position of the tab 31 with respect to the tabs 30 and 32 is established at the design stage, by estimating in advance where the region 41 will occur during operation: this estimate is also carried out by means of appropriate simulations in order to predict the relative axial movements between the static and the rotating parts, due to thermal expansion, depending on the type and operational conditions of the engine, i.e. evaluated for each specific case.

This ensures that the tip 34 of the tab 31 reaches the layer of abradable material 29 so as to engrave it, while leaving an intermediate step having a height or depth (with respect to the bottom of the seats 39, 40) substantially equal to the difference in radial height ΔH between the tab 31 and the tabs 30, 32.

In practice, compared to the known solutions where all the tabs are provided with the same height, the proposed solution comprises adopting an additional intermediate tab having a reduced height, i.e. the tab 31, so as to divide the space between the two tabs 30 and 32 and add a narrow passage cross section between the tip 34 and the surface 38 for the gas flow that tends to leak.

In this way, the overall axial dimension of the seal 25 remains unchanged compared to the known solutions. On one hand, under operative conditions, the seal 25 will work with three tabs 30, 31, 32 which operate at the same distance (the radial clearance C) from the surface 38; on the other hand, the surface 38 maintains the feature of having a step between the seats 39, 40, since the amount of material abraded by the tip 34 is reduced compared to that removed by the tips 33 and 35, thanks to the reduced height of the tab 31.

From the foregoing, therefore, it appears that by maintaining the tortuosity of the “labyrinth” path, mainly due to the step between the seats 39, 40, the resistance for the gas flow that tends to leak is increased compared to similar solutions in which only two tabs 30 and 32 are provided, which have the same height, while still maintaining unchanged the overall axial dimension of the seal 25, thanks to the presence of the additional tab 31, in an intermediate position.

Therefore, the amount of drawn gas which passes through the seal 25 is reduced, the axial dimensions of said seal 25 being equal.

Lastly, from the above it is clear that modifications and variations may be made to the solution described and illustrated with reference to the attached figures without departing from the scope of protection of the present invention, as defined in the appended claims.

The seal 25 can be applied both at the outer radial tip of the bladed rotor 12 and at the internal radial tip of the stator 11; moreover, the seal 25 may be applied to the external surface of a rotating shaft, and not to a part of the bladed rotor 12, and/or to a compressor or a high or medium pressure turbine. Furthermore, the seal 25 may comprise number of tabs greater than three, with a plurality of lower tabs, each of which arranged between two adjacent tabs, which have greater heights that are equal to each other.

1. A gas turbine engine stage, the stage (1) extending along a rotation axis (3) and comprising:
a static part (26);
a rotating part (27); and
a labyrinth seal (25) arranged radially between said static part and rotating part (26, 27) and comprising:
a) a layer of abradable material (29), which is arranged on said static part (26), is continuous in the axial direction and, in an initial assembly configuration, is radially delimited by a cylindrical surface (36) having a constant diameter;
b) at least three tabs (30, 31, 32), that radially project from said rotating part (27), are axially set apart from each other and end with respective tips (33, 34, 35), directly facing said layer of abradable material (29) in the radial direction;
characterized in that said three tabs are constituted bv:
two side tabs (30, 32) and
one intermediate tab (31), which is arranged in an intermediate axial position between said side tabs (30, 32) and has a smaller radial height than that of said side tabs (30, 32);
said intermediate tab (31) having a sufficient radial height to at least nick into said cylindrical surface (36) due to the effect of thermal expansion and of the relative rotation when the gas turbine engine, during operation, reaches a running operational configuration;
the three tabs (30, 31, 32) being axially positioned in such a way that, in the running operational configuration:
the layer of abradable material (29) is radially defined by a shaped surface (38) defining two seats (39, 40), which have been fretted by the tips (33, 35) of said side tabs (30, 32) during operation and are axially separated from each other by a step (41) of said shaped surface (38); and
the tip (34) of said intermediate tab (31) is arranged at said step (41).

2. The stage according to claim 1, characterized in that the difference in radial height (ΔH) between the tip (34) of said intermediate tab and the tips (33, 35) of said side tabs (30, 32) is greater than or equal to a first threshold defined by an estimate of the radial clearance (C) that shall occur in the running operational configuration between the tips (33, 35) of said side tabs (30, 32) and said shaped surface (38).

3. The stage according to claim 1, characterized in that the difference in radial height (ΔH) between the tip (34) of said intermediate tab and the tips (33, 35) of said side tabs (30, 32) is less than or equal to a second threshold defined by the difference between:
an estimate of the maximum relative displacement in the radial direction between the static and rotating parts (26, 27) due to thermal expansion between the initial assembly configuration and the running operational configuration, and
the radial clearance (CF) between the tips (33, 35) of said side tabs (30, 32) and said cylindrical surface (36) in the initial assembly configuration.

4. A low-pressure turbine comprising a stage according to claim 1.
